(19) United States
(12) Patent Application Publication
(10) Pub. No.: US 2006/0256907 A1
(43) Pub. Date: Nov. 16, 2006

(54) Real time clock

(75) Inventors: Robert J. Stalker, Haymarket, VA (US); Vinodh Cuppu, Oceanside, CA (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR INC.

(21) Appl. No.: 11/128,281

(22) Filed: May 13, 2005

(51) Int. Cl. H04L 7/00

(52) U.S. Cl. 375/354

(57) ABSTRACT

A timer circuit is provided. The timer circuit can provide register(s) (105) having information for each of two or more groups, wherein the information for each group indicates a tick count of a first clock signal (109) to count before providing a second clock signal (107). Also, the timer circuit provides circuitry (103), which selects one of the groups to be a current group and initializing a number of ticks. The circuitry (103) receives the first clock signal (109). Responsive to a tick on the first clock signal (109), the circuitry (103) counts the number of ticks. Responsive to the first clock signal (109), when the number of ticks reaches the tick count for the current group, the circuitry (103) provides the second clock signal (107).

### FIELD OF THE INVENTION

The present invention relates in general to real time clocks, and more specifically to providing a clock signal driven from an input reference clock.

### BACKGROUND OF THE INVENTION

In digital technology, it can be desirable to generate a timing signal at a specific frequency, e.g., 16 MHz. Such timing signals can be generated from an input signal, such as a clock signal. It can be fairly straightforward to provide frequency dividers to generate a clock signal from an input signal, for example, by dividing in half the frequency of the input signal, and consequently which reduce the frequency of the input signal by the corresponding power of two.

Similarly, counters can be used to take a clock signal and produce a pulse occurring at some integer factor of the clock frequency. For example, if the clock signal is 200 Hz, and the circuit is configured for a ten-step count, a signal with a period ten times as long (20 Hz) can be provided.

Real time clocks can be used in a variety of electronics applications providing, for example, a timer pulse, a clock, or a clock offset. A wide variety of technology can be utilized in connection with clocks, such as communication devices, other devices using microprocessors, and the like.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a diagram illustrating an example device in accordance with various exemplary embodiments;

FIG. 2 is a timing diagram useful in illustrating an example operation of the device, in accordance with one or more embodiments;

FIG. 3 is a diagram illustrating portions of an exemplary clock device arranged for providing a clock signal in accordance with various exemplary embodiments;

FIG. 4 is a block diagram illustrating portions of an exemplary clock device in accordance with various exemplary embodiments;

FIG. 5 is an exemplary state logic diagram illustrating a first portion of an exemplary state flow in accordance with one or more embodiments;

FIG. 6 is an exemplary state logic diagram illustrating a second portion of an exemplary state flow in accordance with one or more embodiments;

FIG. 7 is an exemplary state logic diagram illustrating a third portion of an exemplary state flow in accordance with one or more embodiments; and

FIG. 8 is a flow chart illustrating an exemplary procedure for facilitating the output clock signal in accordance with various exemplary and alternative exemplary embodiments.

### DETAILED DESCRIPTION

In overview, the present disclosure concerns software, hardware, and/or a combination thereof, and/or components thereof, and the like having a capability to support or being associated with providing clock signals. Such software, hardware, and/or combination, and/or components may be useful in, for example, consumer electronic devices, thermostats, electric lights, low array devices, and the like, for example. Some of these devices may have an ability to transmit and/or receive information. More particularly, various inventive concepts and principles are embodied in systems, circuits, devices, software, and methods therein for providing a real time clock that can be driven from an input reference clock where the period of the output clock can be indivisible by the period of the input clock.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to permit a clock signal having a desired frequency to be generated from an input clock signal, even where the period of the output clock signal is not divisible by the period of the input clock signal. According to one or more embodiments, a digital logic circuit can provide a clock signal, e.g., for measuring elapsed time, providing a timer signal, or incrementing a clock. In overview, one or more embodiments can provide for counting ticks (e.g., rising or falling edges) of an input reference clock and, at an appropriate number of ticks, incrementing a counter and/or providing an output clock signal. One or more embodiments of the circuit can be adjusted to one or more input clock frequencies, and/or a one or more desired output clock frequencies.

Further in accordance with exemplary embodiments, there is provided a real time clock that can accommodate an output timer period that may or may not be divisible by the input clock period. The output timer period can be an approximation of the desired timer period, because an output clock signal generally can change with the input clock signal rising or falling edges, not in between them, except in alternative embodiments halfway between on the falling edge. Parameters for the timer control as further discussed herein can be selected so that the output timer period can alternate between incrementing slightly before and slightly after the desired timer period so that, over a long period of time, an average time interval between output timer periods is equal to the desired output timer period and the accumulated error is or approaches zero.

One or more embodiments can provide that, although instantaneous deviations from the ideal time at which the timer increments (short term accuracy) can occur, an error created by such deviations can be bounded and not accumulate over time. Accordingly, after a lapse of time, a difference between what the output signal should be and what it actually is approaches zero, and the error can be bounded throughout operation of the timer, so that 0<error<maximum error.

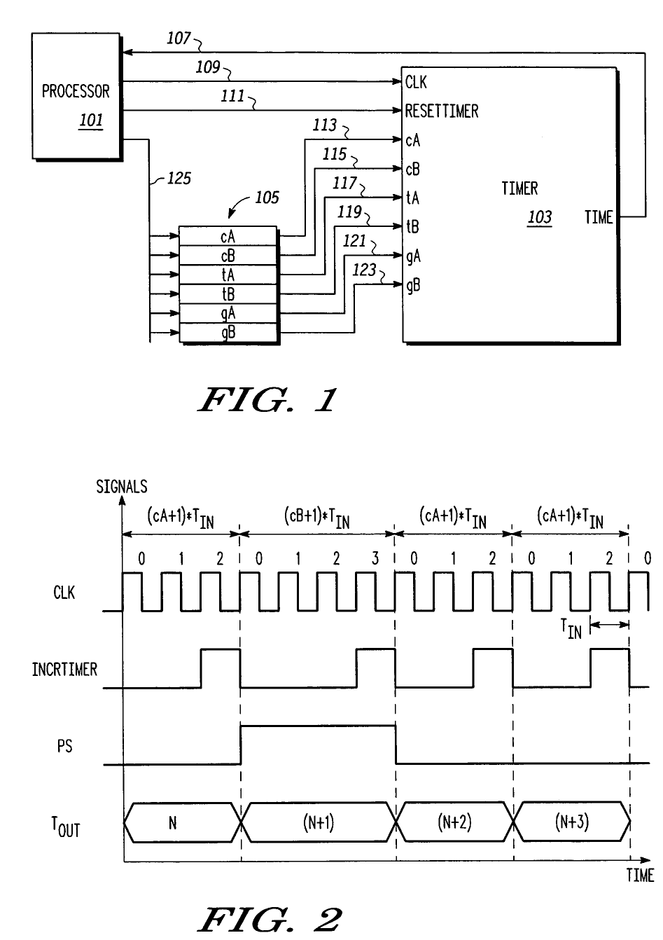

Referring now to FIG. 1, a diagram illustrating an example device in accordance with various exemplary embodiments will be discussed and described. In accordance with one or more embodiments, there is provided a processor 101, a timer 103, and one or more registers 105.

The processor 101 can provide parameters to the registers 105. In the illustrated example, there are six registers that are provided and are connected to the processor 101, for example via a communication bus 125 or are otherwise are in communication therewith. Information in the registers 105 can be retrieved by the timer 103, e.g., via signals 113, 115, 117, 119, 121, 123 and can be utilized by the timer 103 in generating the output clock signal, e.g., a time signal 107. In the illustrated embodiment, the time signal 107 can be received by the processor 101, although alternative embodiments can provide for the time signal 107 to be provided to, e.g., one or more other circuits or other digital components. Additionally, the timer 103 can receive an input clock signal 109, e.g., from the processor 101 or other appropriate source. In accordance with one or more embodiments, the processor can provide a reset timer signal 111, in order to reset the timer 103.

In the illustrated exemplary embodiment, the information in the registers 105 can be parameters provided for use by the timer 103. The parameters in the exemplary embodiments can correlate to cA (number of ticks for group A), cB (number of ticks for group B), gA (number of consecutive times to execute group A), gB (number of consecutive times to execute group B), tA (total number of ticks for group A), and tB (total number of ticks for group B). The use of the parameters is explained below in connection with various examples.

Accordingly, one or more embodiments can provide a timer circuit. The timer circuit comprises at least one register having information for each group of a plurality of groups, wherein the information for each group indicates a tick count of a first clock signal to count before providing a second clock signal.

One or more embodiments provide that the at least one register is incorporated into the timer circuit. Alternatively, the at least one register can be provided in another circuit accessible by the timer circuit. The at least one register, illustrated in the exemplary diagram as six registers, can include, e.g., 8-bit registers, 16-bit registers, or 32-bit registers, or the like, or any combination thereof. The information passed in the register can be, e.g., a value, or an address in a memory location which stores the value.

In accordance with one or more embodiments, the tick count corresponding to one or more groups of the plurality of groups can be different. For example, cA and cB (number of ticks for group A and B) can be 6 and 7, respectively. Further, the number of consecutive times to executive one or more groups of the plurality of groups can be different. For example, gA and gB (number of consecutive times to executive group A and B) can be 1 and 2, respectively. In addition, the total number of ticks for the groups of the plurality of groups can be different. For example, tA and tB can be 10668 and 5332 (output ticks), respectively. In accordance with various embodiments, the total number of ticks for a particular group can be expressed as numbers of output ticks, numbers of input ticks, or numbers of groups that were executed.

As in the illustrated example, two groups can be provided, referred to for convenience as group A and group B. Alternative embodiments can provide for three or more groups.

The timer circuit further comprises circuitry, selecting one of the groups to be a current group and initializing a number of ticks; receiving the first clock signal; responsive to a tick on the first clock signal, counting the number of ticks; and responsive to the first clock signal, when the number of ticks reaches the tick count for the current group, providing the second clock signal. Further, when the tick count is reached, the circuitry repeats, optionally setting a different group to be the current group, where the current group can have a different number of ticks.

The second clock signal can change responsive to rising or falling edges of the first clock signal. Accordingly, the timer period (or number of ticks of the first clock signal) between the second clock signal is selected to shift between being slightly before or slightly after the desired timer period. On average, over time, the second clock signal can be provided at the desired timer period.

A portion of the registers that are provided can be referenced to specify the number of ticks of the first clock signal to be counted as a group of ticks before providing the second clock signal. The circuitry can alternate counting between a number of ticks specified in the various registers. For example, a first and second register can specify groups of ticks to be counted, e.g., a group of 6 ticks and a group of 7 ticks. The circuitry can count the group of 6 ticks of the first clock signal (specified in the first register), provide a tick on the second clock signal, alternate to count the group of 7 ticks of the first clock signal (specified in the second register), provide a tick on the second clock signal, and repeat.

Also, as further discussed below, it may be desirable to repeat the number of ticks specified in one of the register. Referring to the previous example, in order to approach the desired timing, it may be desired to count the group of 6 ticks, then count the group of 6 ticks (again), and then count the group of 7 ticks, all of the first clock signal, and provide a tick on the second clock signal after each group of ticks.

In accordance with one or more embodiments, a failsafe count can be provided, as discussed below in more detail. The failsafe count can ensure that the average time interval over a lapse of time between output timer periods is equal to the desired output timer period.

Parameters for the timer control can be selected as further discussed below so that the output timer period can alternate between incrementing slightly before and slightly after it ideally should so that, over a long period of time, an average time interval between output timer periods can approach or be equal to a desired output timer period.

Exemplary embodiments of the timer 103 and the processor 101 are provided below.

Referring now to FIG. 2, a timing diagram useful in illustrating an example operation of the device in accordance with one or more embodiments will be discussed and described. The timing diagram illustrates the input clock signal CLK, the output clock signal INCRTIMER, the present state signal PS, and the output time value T_{OUT}.

The input clock signal CLK can provide a steady pulse at the corresponding frequency. The input clock signal CLK can be counted as described above for the number of ticks corresponding to group A (cA) (three in this example), and then the output clock signal INCRTIMER is provided. Then, the input clock signal CLK is counted for the number of ticks corresponding to group B (cB) (four in this example), and then the output clock signal is again provided.

The timer period reflecting the actual time between ticks of the output signal can be based on the current group cA or cB. The time for the first illustrated interval is (cA+1)* Tin, and for the second illustrated interval is (cB+1)*Tin, where cA and cB indicate the number of ticks of the input signal (0 to n) for the respective group, and Tin=input clock time period.

In the illustrated example, the number of consecutive times to execute group A (gA) is at least two. The counting of the ticks for one or more of the groups, e.g., group A can be repeated.

The present state signal PS can be provided to indicate which group (A or B) is a current group. In the illustrated example, low or high indication of the PS signal can correlate to group A or B, respectively, as the current group.

The output time value T_{OUT} can be provided as an integer indicating the perceived time (or time offset), according to one or more embodiments, as in the illustrated example. Accordingly, the output time value T_{OUT} is consecutively N, N+1, N+2, N+3, . . .

The output time value T_{OUT}, on average, can accurately reflect the desired output frequency. As will be appreciated from this illustration, however, each particular tick on the output signal INCRTIMER can vary from the desired output frequency, because each particular tick on the output signal INCRTIMER is synchronous with one of the ticks on the input signal.

In the illustrated example, assume that the input clock frequency is 60 MHz, and the desired output clock frequency is 16 MHz. Groups A and B indicate 3 ticks and 4 ticks, respectively. Further, group A is indicated to repeat once. On average, the time period between ticks on the output signal is 3.75 input clock periods (each of which is 16.67 nsec or 1/60 MHz). A pulse in the output clock signal can be provided from the timer on average every 62.5 nsec ( 1/16 MHz). Consequently, the accumulated error between the desired and actual ticks on the output signal tends toward zero.

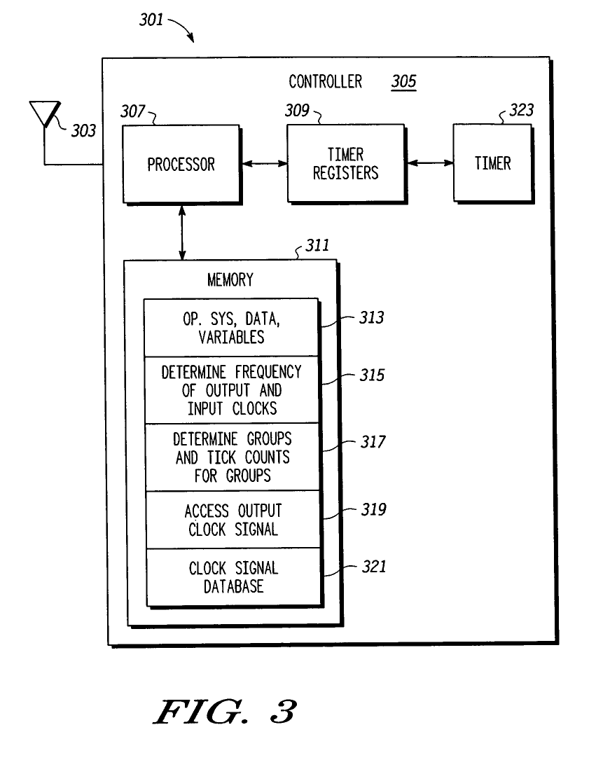

Referring now to FIG. 3, a diagram illustrating portions of an exemplary clock device arranged for providing a clock signal in accordance with various exemplary embodiments will be discussed and described. Examples of such devices and systems include consumer electronic devices, thermostats, electric lights, low array devices, devices for transmitting and/or receiving information, signal processors, signal monitors, personal digital assistants, personal assignment pads, remote transmitters/receivers, personal computers, cellular handsets or devices, and the like, or equivalents thereof.

The device 301 can include a transceiver 303, one or more controllers 305. The controller can include a timer 323 and timer registers 309 for providing parameters to the processor 307.

The processor 307 can comprise one or more microprocessors, digital signal processors, and/or other processing circuitry for executing instructions. The memory 311 can be coupled to the processor 307 and can comprise a read-only memory (ROM), a random-access memory (RAM), a programmable ROM (PROM), and/or an electrically erasable read-only memory (EEPROM). The memory 311 can include multiple memory locations for storing, among other things, an operating system, data and variables 313 for programs executed by the processor 307; computer programs for causing the processor to operate in connection with various functions such as determining frequency of output and input clocks 315, determining groups and tick counts for groups 317, and accessing the output clock signal 319; and a database 321 of information used by the processor 307 such as pre-determined input frequency/output frequency ratios and correlated group and tick counts. The computer programs can be stored, for example, in ROM or PROM and may direct the processor 307 in controlling the operation of the device 301.

The computer programs can be provided in any computer-readable electronic format, including, for example, over a communication line as electronic signals, on magnetic media, on optical media, and the like. Accordingly, one or more embodiments provides a computer-readable medium comprising instructions executable by a processor.

The transceiver 303 can be responsive to a signal that the processor 307 indicates should be transmitted, e.g., a digital signal. For example, the controller 305 can process signals, e.g., in connection with a timer, and can provide the signals to be output.

The processor 307 can be programmed for determining frequency of output and input clock signals 315. In accordance with one or more embodiments, the frequency of the output signal and/or the input clock signal can be determined by being manually indicated, e.g., by interaction with a user who provides the frequency/ies as input into the processor via, e.g., a keyboard, touch screen, etc. Alternative embodiments can provide that the frequency of the output signal and/or input clock signal are electrically detected, indicated as a default, pre-programmed into the processor, selected by switches, or the like, or any combination thereof. Accordingly, the processor 307 can be cooperatively operable with the at least one register 309 and the circuitry 323, the processor 307 being configured to facilitate first determining a frequency of the first clock signal; second determining a frequency of the second clock signal; responsive to the frequencies, calculating the plurality of groups and the information for each group; and indicating the information on the at least one register 309.

The processor 307 can be programmed for determining groups and tick counts for groups 317, or a manual determination of the same can be performed. The groups and tick counts can be determined in accordance with one or more embodiments by being manually indicated, e.g., by interaction with the user, by reference to a database or memory indicating one or more sets of groups and tick counts. One or more alternative embodiments can provide that the processor is programmed to determine groups and tick counts based on the frequency of the input clock signal and frequency of the output clock signal, using the equation:
((t1*c1)+(t2*c2))/(t1+t2)=(Tout/Tin), (1)
where:

Tin=input clock period

Tout=desired timer increment interval

c1=number of input clock periods between timer increment.

c2=number of input clock periods between timer increment (alternate).

t1=total number of times to increment timer after c1 clocks periods elapse.

t2=total number of times to increment timer after c2 clocks periods elapse.

Since Tout and Tin are given, it follows that parameters t1, t2, c1, and c2 can be selected as appropriate.

Tick counts for the groups can be determined as in the following exemplary illustration. To reduce an upper error bound, the g1, g2 parameters can be chosen so that their ratio is equal to the ratio of c1 to c2, or in other words:
g1/g2=c1/c2, (2)
where

g1=total number of times to consecutively increment timer after c1 clock periods.

g2=total number of times to consecutively increment timer after c2 clock periods.

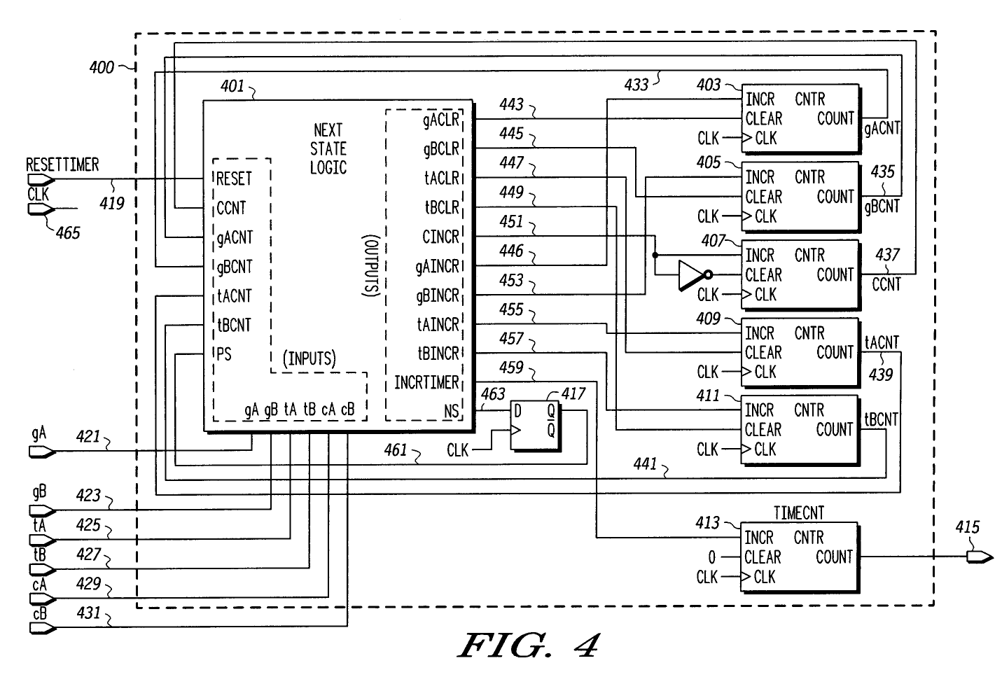

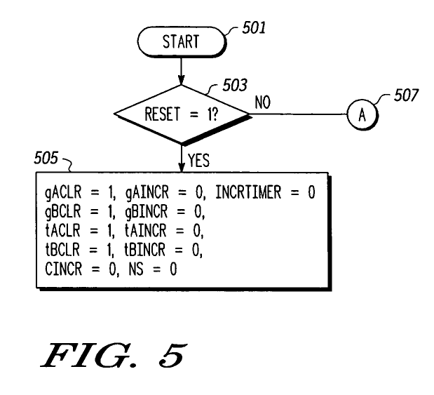

Parameters g1, g2 do not affect the average time interval, but they can affect the maximum error that the timer exhibits. A more detailed analysis is provided below in connection with FIG. 4.

The timer accuracy can depend on a stable reference input clock. A deviation in the input clock reference can induce the same amount of error in the timer output. E.g., if the input reference clock is only accurate to 25 PPM (parts per million), then an accuracy of the timer will be 25 PPM.

One or more embodiments can provide a failsafe re-synchronization. A running total number of the number of ticks of the input clock signal can be counted. The running total can be compared to a desired total that are determined to elapse before the output and input clocks should experience a synchronous pulse. For example, where the input clock signal is 101.322 MHz and the output clock signal is 16 MHz, group A can be 6 ticks and group B can be 7 ticks, and group A is repeated once. Then, 16,000 total ticks of the output clock signal should occur before the input and output clocks are synchronous. (Number of output ticks includes 10,668 generated from group A and 5,332 generated from group B.) Alternatively, a failsafe can count the number of ticks of the input clock, or can count ticks per group, or the like. The processor 307 can be programmed to determine one or more failsafe numbers, which can be provided to the timer 323. The timer 323 can then compare the failsafe numbers to the numbers it is counting, and take appropriate action such as re-synching or issuing an error signal when the failsafe number has been reached.

In accordance with one or more embodiments, the processor 307 can be programmed for use in connection with a database 321 of information used by the processor 307 such as pre-determined input frequency/output frequency ratios and correlated group and tick counts as discussed above.

Accordingly, one or more embodiments provides for instructions for execution by a computer, the instructions including a computer-implemented method for facilitating an output clock signal responsive to an input clock signal, where the period of the output clock signal is not divisible by the period of the input clock signal. The instructions can implement the steps of: first determining a frequency of the input clock signal; second determining the frequency of an output clock signal; responsive to the frequencies, third determining a plurality of groups, wherein each group indicates a number of ticks of the input clock signal to count before incrementing an output clock; and providing the information representative of the plurality of groups to a timer circuit 323. In accordance with one or more embodiments, the instructions can determine a total count for each of the groups, wherein the total count represents a total number of ticks of the input clock signal to synchronize with the output clock signal. Further in accordance with one or more embodiments, the third determining can further include calculating the number of ticks for each group, where the number constitutes a set of ticks; and calculating a group size for each group, where a group size indicates a number of sets to be repeated consecutive times.

In accordance with one or more embodiments, the timer 323 can be configured to facilitate counting ticks for the current group, generating an appropriate signal when the tick count per group is reached, and alternating to one of the other groups and/or repeating the current group. The timer 323 can be configured to facilitate repeating a group, where indicated. Additionally, one or more embodiments of the timer 323 can be configured for the failsafe operation. An exemplary embodiment of the timer 323 is discussed in more detail in connection with FIG. 4-FIG. 7.

As shown in the illustration, the signal can be transmitted over a transceiver 303. Various types of transmitters are appropriate, e.g., an impulse radio transmitter, short wave transmitter, other transmitters, or the like. The transmitter function can be provided in a transceiver, according to one or more embodiments. (The term “impulse radio” as used herein is intended to encompass not only radios conventionally referred to as “impulse radios”, but also bi-phase radios, and the like.) Accordingly, one or more embodiments provide a device 301, wherein the at least one register and the circuitry is incorporated in a communication device, and the second clock signal is utilized in connection with communication, e.g., as timer input to a circuit providing the transmission at a specific frequency.

FIG. 4-FIG. 7 provide an overview of an embodiments of an exemplary clock device. In particular, FIG. 4 is an exemplary circuit diagram, and FIG. 5-FIG. 7 together provide a state logic diagram illustrating the states of the signals of the exemplary circuit diagram in FIG. 4.

Referring now to FIG. 4, a block diagram illustrating portions of an exemplary clock device 400 in accordance with various exemplary embodiments will be discussed and described. In overview, portions of the exemplary clock device 400 can include a next state logic circuit 401, counters 403, 405, 407, 409, 411, and a time counter 413. In the illustrated embodiment, the digital logic circuit is fully synchronous.

Inputs to the clock device 400 and further to the next state logic circuit 401 can include signals 421, 423, 425, 427, 429, 431 providing parameters which can be provided for example from a register, or which can be pre-determined. In the exemplary embodiments, the parameters can include group sizes for the respective groups, where group size is the number of consecutive times a group of ticks is counted: gA 421 (group of ticks for group A), gB 423 (group of ticks for group B); total number of times to increment the output timer before the input and output clocks should be synchronous, for the respective groups: tA 425 (total for group A), tB (total for group B); and number of input clock ticks to receive before incrementing the output timer: cA 429 (number of ticks for group A), and cB 431 (number of ticks for group B). Also provided as input to the clock device 400 can be the input clock signal 465, and an optional reset timer signal 419.

The output from the clock device 400 can be an output clock signal 415. In the illustrated embodiment, the output clock signal 415 can receive an indication of the time from the time counter 413, and the output clock signal 415 can be an integer representative of the time. In alternative embodiments, the output clock signal 415 can provide a pulse. The time counter 413 can be incremented at the appropriate time by the next state logic circuit 401, which can provide an increment time signal 459.

The counters 403, 405, 407, 409, 411 can be provided in the clock device 400 to count ticks of the input clock for the respective groups. The counters can include group tick counters, 403, 405, incoming clock tick counter 407, and total group tick counters 409, 411. In the illustrated embodiment, each of the counters 403, 405, 407, 409, 411 can receive the input clock signal 465, and therefore can increment upon receipt of ticks on the input clock signal 465.

The incoming clock tick counter 407 can count the current number of ticks. For example, group A and group B can be programmed to count 3 ticks and 4 ticks, respectively. The incoming clock tick counter 407 can count ticks for the one of the groups that is the current group, e.g., group A or group B. In the illustrated embodiment, only one incoming clock tick counter 407 is utilized, because only one of group A or group B can be counted at a time. The incoming clock tick counter 407 can provide a clock counter ccnt output signal 437. The next state logic circuit 401 can provide an indication that the counter is to be incremented via a cincr signal 451. The incoming clock tick counter 407 can be cleared at the appropriate time, e.g., when a group tick count is reached.

The group tick counters, 403, 405, can count the number of groups of ticks for each respective group. The counters 403, 405 can be incremented when a complete group of ticks is counted for the respective group, when that group is the current group. The next state logic circuit 401 can provide an indication that the counter is to be incremented via a gAincr signal 446 or a gBincr signal 453. The next state logic circuit 401 can clear the counters by providing a group A clear gAclr signal 443 or a group B clear gBclr signal 445, when the group tick count is reached, so that the next group (A or B) can be used for counting. For example, it may be desirable for group A to count 11 groups of 3 ticks. The group tick counter for group A 433 can count the 11 groups, and then the group A tick counter 443 can be reset. The group tick counter for group A 433 or group B 435 can output the group A count gAcnt signal 433 or group B count gBcnt signal 435, respectively.

The total group tick counters 409, 411 can provide a continuous count of the total number of groups of ticks for each respective group. The counters 409, 411 can be incremented when a complete group of ticks is counted for the respective group, when that group is the current group. The next state logic circuit 401 can provide an indication that the counter is to be incremented via a tAincr signal 455 or a tBincr signal 457. The total group tick counter for each group A 409 or group B 401 can output the total A count tAcnt signal 439 or total B count tBcnt signal 441, respectively. The next state logic circuit 401 can clear the counters by providing a total A clear tAclr signal 447 or a total B clear tBclr signal 449, when the total tick count is reached.

One or more embodiments provide that the next state logic circuit 401 can track which of the groups is the current group or next group by a PS (present state) input 461 and NS (next state) signal 463. A gate 417 on the NS signal 463 can provide that the indication alternates, such that group A and group B can be alternated.

Accordingly, one or more embodiments can provide a circuit 401 that further counts a total number of ticks of the first clock signal for each of the groups when each group is the current group. Further, the circuitry can receive an indication of a desired total count representing a total number of ticks of the first clock signal to synchronize to the second clock signal, and when the total of the number of ticks for each of the groups when combined is equal to the desired total count, can provide the second clock signal and re-starting counting of the number of ticks and the total number of ticks.

Accordingly, one or more embodiments can provide that the tick count is a set of ticks. Also provided can be a counter corresponding to at least one group of the plurality of groups, wherein the counter corresponding to the current group can perform the counting of the number of sets of ticks for the corresponding at least one group.

In accordance with one or more embodiments, there can be provided a counter counting the number of ticks, wherein the counter resets when the second clock signal is provided.

Further in accordance with one or more embodiments the circuitry further can receive an indication of the consecutive times to execute each group, the counting of the number of ticks for the particular group being repeated for the consecutive times.

In accordance with one or more embodiments, providing the second clock signal can comprise at least one of incrementing an output clock and generating a tick on the second clock signal.

The following provides additional detail on the exemplary embodiments illustrated in FIG. 4 in relation to equations (1) and (2). The six parameters c1, c2, t1, t2, g1, g2 are related to the information stored in the parameter registers cA, cB, tA, tB, gA, gB: cA=c1−1, cB=c2−1, tA=t1−1, tB=t2−1, gA=g1−1, and gB=g2−1.

In operation of one or more embodiments, the processor can compute the parameters c1, c2, g1, g2, t1, and t2 according to the equations (1) and (2) above, subtract one from each value, and store the result in the 6 registers that feed the timer circuit. The following steps can be performed:

0. Clear all internal states and counters to zero.

1. Count c1 input clock periods, then increment timer (unless total count is exceeded).

2. Repeat step #1, g1 times.

3. Count c2 input clock periods, then increment timer (unless total count is exceeded).

4. Continue step #3, g2 times.

5. Repeat steps 1-4 until the timer has been incremented c1 input clock periods apart, t1 total times.

After step 5, the output clock timer has been incremented c2 input clock periods apart, t2 total times.

6. Go to step 0 and repeat steps 0-5.

The following is a mathematical analysis providing a further explanation of the counting explained herein. The following terms are defined for the following equations. The timer circuit has 6 total adjustable parameters: c1, c2, t1, t2, g1, g2. Tin is a given, as is Tout.

Tin—input clock period

Tout—desired timer increment interval

c1—number of input clock periods between timer increment.

c2—number of input clock periods between timer increment (alternate).

t1—total number of times to increment timer after c1 clocks periods elapse.

t2—total number of times to increment timer after c2 clocks periods elapse.

g1—total number of times to consecutively increment timer after c1 clock periods.

g2—total number of times to consecutively increment timer after c2 clock periods.

Each time a pass through steps 0-5 has been completed, a total time of:
(t1*(c1*Tin))+(t2*(c2*Tin)) (3)
has elapsed. An average value for the time interval between timer increments (i.e., the quantities (c1*Tin) and (c2*Tin)), namely Tavg, can be calculated by noting that (3) is equal to:
(t1*Tavg)+(t2*Tavg) (4)

By equating quantities (3) and (4), we arrive at:
(t1*(c1*Tin))+(t2*(c2*Tin))=(t1*Tavg)+(t2*Tavg) (5)

We can simplify equation (5) by factorization to this:
((t1*c1)+(t2*c2))*Tin=(t1+t2)*Tavg (6)

Finally, by rearranging terms:
Tavg=[((t1*c1)+(t2*c2))*Tin]/(t1+t2) (7)

If we want the average time interval to be equal to Tout (the desired output frequency), then:
Tout=[((t1*c1)+(t2*c2))*Tin]/(t1+t2) (8)

or by rearranging,
((t1*c1)+(t2*c2))/(t1+t2)=(Tout/Tin) (9)

Since we know Tout and Tin, it follows that we must choose parameters t1, t2, c1, and c2 so that the left hand side of equation (8) is equal to the right hand side.

Parameters g1, g2 from the foregoing do not have any effect on the average time interval, but they can affect the maximum error that the timer exhibits. To minimize this upper error bound, the g1, g2 parameters can be chosen so that their ratio is equal to the ratio of c1 to c2, or in other words,
g1/g2=c1/c2 (10)

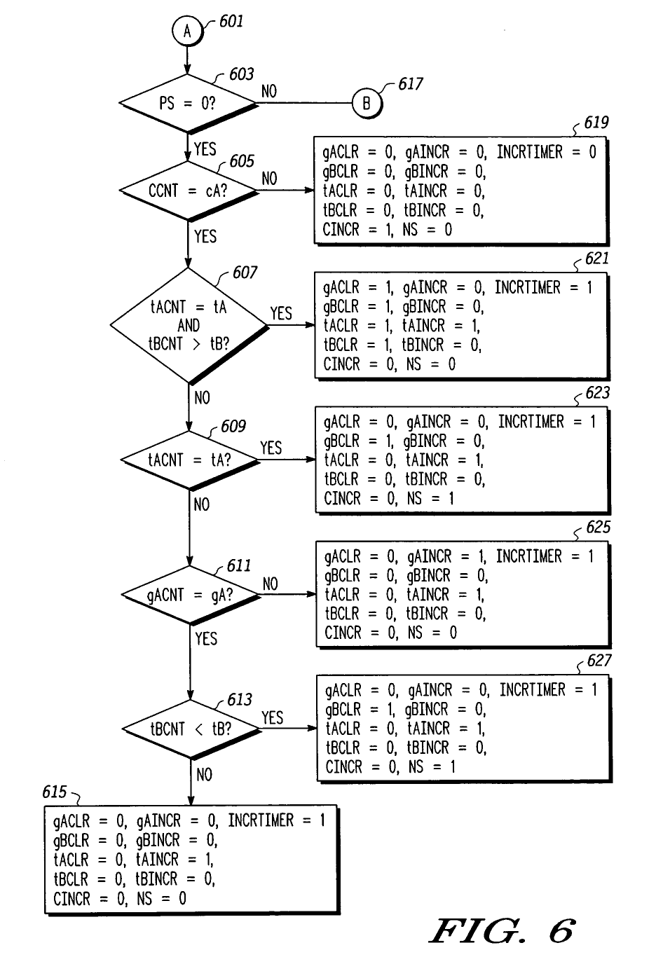

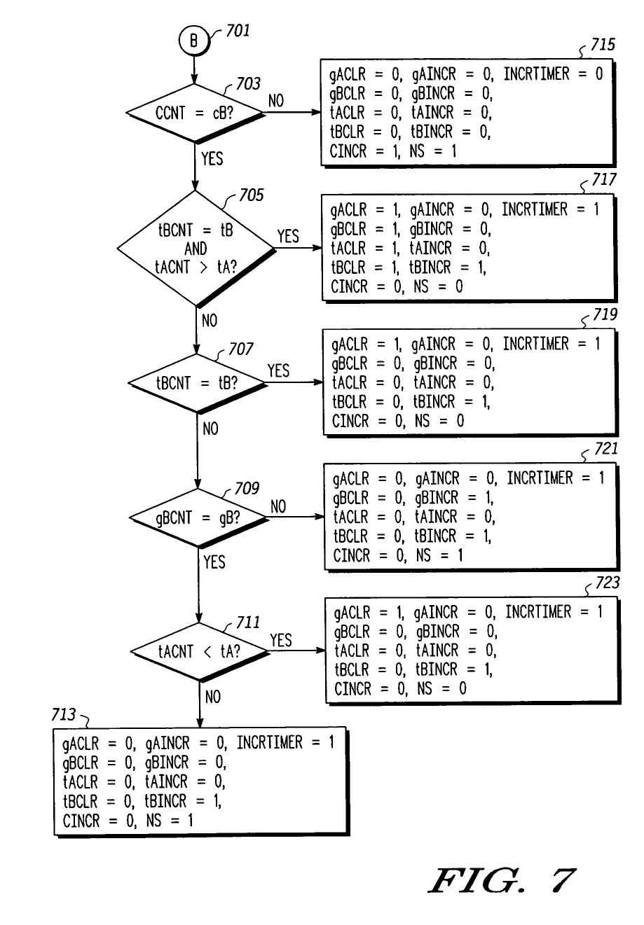

FIG. 5-FIG. 7 together provide an exemplary combinatorial state logic diagram illustrating the next states of a finite state machine, provided in one embodiment as the exemplary circuit diagram in FIG. 4. In overview, FIG. 5 provides the reset control, FIG. 6 generally attends to the group A logic, and FIG. 7 generally attends to the group B logic. FIG. 6 is a continuation of FIG. 5 at indicator A 507, and FIG. 7 is a continuation of FIG. 6 at indicator B 617.

Referring now to FIG. 5, an exemplary state logic diagram illustrating a first portion of an exemplary state flow in accordance with one or more embodiments will be discussed and described. After starting the process 501, the process provides for determining whether the circuit is being reset 503. If so, this causes a clear of the counters to zero. If the circuit is not being reset 503, then the description proceeds to indicator A 507, in FIG. 6 601.

Referring now to FIG. 6, an exemplary state logic diagram illustrating a second portion of an exemplary state flow in accordance with one or more embodiments will be discussed and described. FIG. 6 generally describes logic associated with group A.

The process provides for checking the present state, PS. If the present state is not 0, thereby indicating group A as the current group, then the flow proceeds to indicator B 617, in FIG. 7 701.

However, if group A is the current group, then the process provides for determining 605 whether the clock count currently equals cA, the maximum clock count for group A. If not, then the process provides for incrementing 619 the clock count (cCNT), and the flow proceeds to start at the top, FIG. 5.

The process then checks 607 whether the maximum total tick count for A and the maximum total tick count for B has been reached, i.e., whether tAcnt=tA and tBcnt>tB. If so, then the process provides for incrementing 621 the tick counter, and clearing all other counters; and the flow proceeds to re-start at the top, FIG. 5.

Otherwise, then the process checks 609 whether the total tick count for A (tAcnt) has reach the maximum total tick count for A (tA). If so, then the process provides for incrementing 623 the tick counter, clearing the group count for B, incrementing the total tick count for A, changing the next state to B, and clearing the clock count; and the flow proceeds to re-start at the top, FIG. 5.

Otherwise, then the process checks 611 whether the group count for A (gAcnt) has reached the maximum group count for A, gA. If not, then the process provides for incrementing 625 the tick counter, incrementing the group count for A, incrementing the total tick count for A, and clearing the clock count; and the flow proceeds to re-start at the top, FIG. 5.

Otherwise, then the process checks 613 whether the total tick count for B (tBcnt) is less than the maximum total tick count for B (tB). If so, then the process provides for incrementing 627 the tick counter, clearing the group count for B, incrementing the total tick count for A, changing the next state to B, and clearing the clock count; and the flow proceeds to re-start at the top, FIG. 5.

Otherwise, the process provides for incrementing 615 the tick counter, incrementing the total tick count for A, and clearing the clock count. The flow then proceeds to re-start at the top, FIG. 5.

Referring now to FIG. 7, an exemplary state logic diagram illustrating a third portion of an exemplary state flow in accordance with one or more embodiments will be discussed and described. FIG. 7 generally describes logic associated with the group B.

The process provides for determining 703 whether the clock count currently equals cB, the maximum clock count for group B. If not, then the process provides for incrementing 715 the clock count (cCnt), and the flow proceeds to start at the top, FIG. 5.

The process then checks 705 whether the maximum total tick count for A and the maximum total tick count for B has been reached, i.e., whether tBcnt=tB and tAcnt>tA. If so, then the process provides for incrementing 717 the tick counter, and clearing all other counters; and the flow proceeds to re-start at the top, FIG. 5.

Otherwise, then the process checks 707 whether the total tick count for B (tBcnt) has reached the maximum total tick count for B (tB). If so, then the process provides for incrementing 719 the tick counter, clearing the group count for A, incrementing the total tick count for B, changing the next state to A, and clearing the clock count; and the flow proceeds to re-start at the top, FIG. 5.

Otherwise, then the process checks 709 whether the group count for B (gBcnt) has reached the maximum group count for B, gB. If not, then the process provides for incrementing 721 the tick counter, incrementing the groun count for B, incrementing the total tick count for B, and clearing the clock count; and the flow proceeds to re-start at the top, FIG. 5.

Otherwise, then the process checks 711 whether the total tick count for A (tAcnt) is less than the maximum total tick count for A (tA). If so, then the process provides for incrementing 723 the tick counter, clearing the group count for A, incrementing the total tick count for B, changing the next state to A, and clearing the clock count; and the flow proceeds to re-start at the top, FIG. 5.

Otherwise, the process provides for incrementing 713 the tick counter, incrementing the total tick count for B, and clearing the clock count. The flow then proceeds to re-start at the top, FIG. 5.

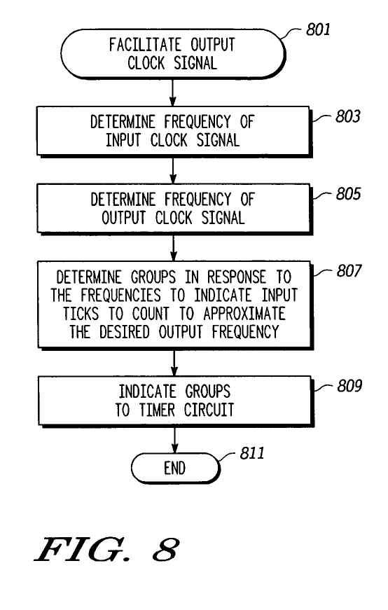

Referring now to FIG. 8, a flow chart illustrating an exemplary procedure 801 for facilitating the output clock signal in accordance with various exemplary and alternative exemplary embodiments will be discussed and described. The procedure 801 can advantageously be implemented on, for example, a processor of a controller, described in connection with FIG. 3 or other apparatus appropriately arranged.

The illustrated exemplary procedure 801 for facilitating the output clock signal can generally determine the inputs to be provided to a timer circuit. It can include determining 803 the frequency of an input clock signal, determining 805 the frequency of the output clock signal. Further, it can include determining 807 groups in response to the frequencies to indicate input ticks to be counted to approximate the desired output frequency. Also, the illustrated exemplary procedure can indicate 809 the groups to, e.g., a timer circuit.

The process can provide for determining 803 the frequency of an input clock signal. The frequency can be determined as explained above in connection with various embodiments.

The process can provide for determining 805 the frequency of the output clock signal. One or more embodiments for determining the frequency of the output clock have been previously discussed.

The process can provide for determining 807 groups in response to the frequencies to indicate input ticks to be counted to approximate the desired output frequency. Various exemplary embodiments for determining the groups have been discussed previously.

Also, the illustrated exemplary procedure can provide for indicating 809 the groups to, e.g., a timer circuit. One or more embodiment for providing indications of the groups to timer circuits have been previously discussed. When processing is completed, the exemplary procedure can end 811.

Accordingly, one or more embodiments can provide a method for facilitating an output clock signal responsive to an input clock signal, where the period of the output clock signal is not divisible by the period of the input clock signal. The method can include receiving information for each group of a plurality of groups, wherein the information for each group indicates a tick count of the input clock signal to count before providing the output clock signal. The method further can include selecting one of the groups to be a current group and initializing a number of ticks. The method also can include receiving the input clock signal. Further, the method can include, responsive to a tick on the input clock signal, counting the number of ticks, and, when the number of ticks reaches the tick count for the current group, providing the output clock signal.

In accordance with one or more embodiments, there is provided a counter for each group of the plurality of groups. Accordingly, the method can provide for the counter counting the total number of ticks for the respective group.

It should be noted that the term communication device may be used herein to denote a wired device, for example a high speed modem, an xDSL type modem, a wireline UWB device, and the like, and a wireless device, and typically a wireless device that may be used with a public network, for example in accordance with a service agreement, or within a private network such as an enterprise network or an ad hoc network. Examples of such communication devices include a cellular handset or device, television apparatus, personal digital assistants, personal assignment pads, and personal computers equipped for wireless operation, and the like, or equivalents thereof, provided such devices are arranged and constructed for operation in connection with wired or wireless communication.

The wireless communication devices of interest may have short range wireless communications capability normally referred to as WLAN (wireless local area network) capabilities, such as IEEE 802.11, Bluetooth, WPAN (wireless personal area network) or Hiper-Lan and the like using, for example, CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication devices of interest may be connected to a LAN using protocols such as TCP/IP, UDP/UP, IPX/SPX, or Net BIOS via a hardwired interface such as a cable and/or a connector

The communication devices of particular interest are those providing or facilitating voice communications services or data or messaging services over ultra wideband networks, cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A timer circuit, comprising:
at least one register having information for each group of a plurality of groups, wherein the information for each group indicates a tick count of a first clock signal to count before providing a second clock signal; and
circuitry, selecting one of the groups to be a current group and initializing a number of ticks; receiving the first clock signal; responsive to a tick on the first clock signal, counting the number of ticks; and responsive to the first clock signal, when the number of ticks reaches the tick count for the current group, providing the second clock signal.

2. The device of claim 1, wherein the circuit further counts a total number of ticks of the first clock signal for each of the groups when each group is the current group.

3. The device of claim 2, wherein the circuitry receives an indication of a desired total count representing a total number of ticks of the first clock signal to synchronize to the second clock signal, and when the total of the number of ticks for each of the groups when combined is equal to the desired total count, providing the second clock signal and re-starting counting of the number of ticks and the total number of ticks.

4. The device of claim 1, wherein the tick count is a set of ticks, further comprising a counter corresponding to at least one group of the plurality of groups, wherein the counter corresponding to the current group performs the counting of the number of sets of ticks for the corresponding at least one group.

5. The device of claim 1, further comprising a counter counting the number of ticks, wherein the counter resets when the second clock signal is provided.

6. The device of claim 1, wherein the circuitry further receives an indication of the consecutive times to execute each group, the counting of the number of ticks for the particular group being repeated for the consecutive times.

7. The device of claim 1, wherein providing the second clock signal comprises at least one of incrementing an output clock and generating a tick on the second clock signal.

8. The device of claim 1, wherein the at least one register and the circuitry is incorporated in a communication device, and the second clock signal is utilized in connection with communication.

9. The device of claim 1, further comprising a processor cooperatively operable with the at least one register and the circuitry, the processor being configured to facilitate first determining a frequency of the first clock signal; second determining a frequency of the second clock signal; responsive to the frequencies, calculating the plurality of groups and the information for each group; and indicating the information on the at least one register.

10. A method for facilitating an output clock signal responsive to an input clock signal, where the period of the output clock signal is not divisible by the period of the input clock signal, comprising:
receiving information for each group of a plurality of groups, wherein the information for each group indicates a tick count of the input clock signal to count before providing the output clock signal;
selecting one of the groups to be a current group and initializing a number of ticks;
receiving the input clock signal;
responsive to a tick on the input clock signal, counting the number of ticks, and, when the number of ticks reaches the tick count for the current group, providing the output clock signal.

11. The method of claim 10, wherein the counting is a first counting, further comprising second counting a total number of ticks of the input clock signal for each of the groups when each group is the current group.

12. The method of claim 11, further comprising receiving an indication of a desired total count representing a total number of ticks of the input clock signal to synchronize to the second clock signal, and when the total of the number of ticks for each of the groups when combined is equal to the desired total count, re-starting counting of the number of ticks and the total number of ticks.

13. The method of claim 11, further comprising a counter for each group of the plurality of groups, wherein the counter counts the total number of ticks for the respective group.

14. The method of claim 10, further comprising a counter corresponding to at least one group of the plurality of groups, wherein the counter corresponding to the current group performs the counting of the number of ticks responsive to the first clock signal, and the counter is reset when the tick count for the current group is reached.

15. The method of claim 10, further comprising counting, in a counter, the number of ticks, and resetting the counter when the second clock signal is provided.

16. The method of claim 10, further comprising receiving an indication of the consecutive times to execute each group, wherein the counting the number of ticks for the particular group is repeated for the consecutive times.

17. The method of claim 10, wherein providing the second clock signal comprises at least one of incrementing an output clock and generating a tick on the second clock signal.

18. A computer-readable medium comprising instructions for execution by a computer, the instructions including a computer-implemented method for facilitating an output clock signal responsive to an input clock signal, where the period of the output clock signal is not divisible by the period of the input clock signal, the instructions for implementing the steps of:
first determining a frequency of the input clock signal;
second determining the frequency of an output clock signal;
responsive to the frequencies, third determining a plurality of groups, wherein each group indicates a number of ticks of the input clock signal to count before incrementing an output clock; and
providing the information representative of the plurality of groups to a timer circuit.

19. The computer-readable medium of claim 18, further comprising instructions for determining a total count for each of the groups, wherein the total count represents a total number of ticks of the input clock signal to synchronize with the output clock signal.

20. The computer-readable medium of claim 18, wherein the third determining further includes calculating the number of ticks for each group, where the number constitutes a set of ticks; and calculating a group size for each group, where a group size indicates a number of sets to be repeated consecutive times.
